(19) United States
(12) Patent Application Publication
(10) Pub. No.: US 2004/0211242 A1
(43) Pub. Date: Oct. 28, 2004

(54) Multi-purpose monitoring system

(76) Inventor: Ekhson Holmuhamedov, Rochester, MN (US)

Correspondence Address: SCHWEGMAN, LUNDBERG, WOESSNER & KLUTH, P.A., P.O. BOX 2938, MINNEAPOLIS, MN, 55402, US

(21) Appl. No.: 10/423,453

(22) Filed: Apr. 25, 2003

(51) Int. Cl. G01N 25/00

(52) U.S. Cl. 73/23.2

(57) ABSTRACT

A multipurpose monitoring system provides instantaneous, simultaneous and continuous acquisition and storage of changes in concentrations of oxygen and inorganic ions such as Ca²⁺, K⁺, H⁺, TPP⁺, the changes in the intensity of light scattered by a sample and changes in the fluorescence of the sample. The system provides for simultaneous operation of three (or more) ion-selective electrodes using a single reference electrode having a high polarization limit. The electrodes are laterally integrated into a measuring chamber having low volume. The design of the chamber and holders for the electrodes provide for a hermetically sealed attachment of electrodes within the chamber. In addition, the system integrates an electrically insulated oxygen sensor, allowing simultaneous measurements of the concentration ionic composition and dissolved oxygen in aqueous solutions.

### FIELD OF THE INVENTION

The present invention relates to monitoring systems, and in particular, to a multipurpose monitoring system.

### BACKGROUND OF THE INVENTION

Instruments utilized for quantitative and semi-quantitative characterization of the biological processes using several measuring sensors where each sensor independently measures a single parameter with a single measuring sensor attached to a separate measuring unit. The sensors operate based on the exploration of the principles and methods of electroanalytical chemistry, the field of analytical chemistry exploiting and studying the charge-transfer phenomena. As such, the field of electrochemistry includes application of electrochemical cells and electrochemical techniques for chemical analysis. An analyte is dissolved in the electrolyte of the electrochemical cell, and one can perform either “qualitative” analysis (determination of the type of constituents present) or “quantitative” analysis (determination of the amount of a given constituent) using variety approaches. Potentiometric and polarographic techniques are among the most conventional approaches of electroanalytical chemistry widely used in biological applications.

The inefficiencies of conventional single channel measurements are well known, although no research and development efforts has been expended over more 30 years in attempting to provide improved multi-channel monitoring systems for medico-biological applications. The Pressman's cell (1968) is an example of such a proposal, but this suffers from some of the drawbacks of conventional single sensor-based measurements and has problems of its own. At present, there is no commercially available system allowing monitoring simultaneously multiple parameters of the biological samples.

Ion-selective electrodes are electronic devices used for continuous measurements of the activity of appropriate ions (example: pH electrode, which is widely used to measure the concentration of free H+ ions in aqueous solutions).

Current device are limited to use of large electrodes and do not allow reduction of the sample volume. Large electrodes are not conducive to allowing a reduction of the volume of a vessel holding the sample, thus making it difficult to place an ion-selective and a reference electrode within the small volume of a measuring chamber. Larger samples are required for testing.

Electrodes are also mounted in the vessel from above, restricting access to the incubation medium during measurements.

### SUMMARY OF THE INVENTION

A multipurpose monitoring system provides instantaneous, simultaneous and continuous monitoring, acquisition and storage of the information on biological processes occurring in a variety of aqueous solutions such as biological samples including mitochondria, nuclei, bacteria, fungi, suspension of mammalian cells and others.

The system facilitates simultaneous operation of multiple ion-selective electrodes using a single reference electrode. The electrodes are integrated into a measuring chamber having a small volume. The design of the chamber and holders for the electrodes provide an environment for a hermetically sealed attachment of electrodes within the measuring chamber. In one embodiment, the sensors are horizontally disposed about the chamber such that ends of the sensor access the sample laterally, or from the sides of the chamber.

In addition, the system may integrate an oxygen sensor, allowing simultaneous measurements of the concentration of ionic composition and dissolved oxygen in aqueous solutions. Oxygen consumption by biological samples (example: mitochondria, cells) is the main characteristic of aerobic metabolism and energetic status of the cell. The design of an oxygen sensor uses a gas-permeable membrane, which separates internal electrolyte of the oxygen sensor from incubation medium, and also provides electrical insulation of a powered (−650 mV) negative Pt electrode from incubation medium, thus preventing electrical contact between biological sample, Pt electrode and other ion-selective electrodes. The design of oxygen sensor, other electrodes and the measuring chamber allow fast and effective attachment of the sensor into the body of measuring chamber, as well as replacement of the gas semi-permeable membrane on the oxygen sensor. Electrical insulation of internal powered space of the sensor from external incubation medium is achieved through design of the body of the sensor and the type of gas-permeable membrane.

The multipurpose monitoring system allows instantaneous, simultaneous and continuous acquisition, visualization, storage and off-line analysis of the information on the concentrations of vital analytes (measured with ion selective electrodes), oxygen concentration (measured with Clark-style oxygen sensor), the volume of the particles (measured from light scattering) and the redox status of intracellular pyridine nucleotides (measured from autofluorescence) in biological samples. The design of the measuring chamber allows easy access and convenient manipulation of the sample during measurements.

### BRIEF DESCRIPTION OF THE DRAWINGS

FIG. 1 is a cross section of an example multi-sensor monitoring system.

FIG. 2 is a top sectional view of a chamber having multiple laterally spaced sensors.

FIG. 3 is a perspective view of the chamber of FIG. 2.

FIG. 4 is a perspective view of the chamber of FIG. 2 showing multiple sensors for insertion into through holes of the chamber.

FIG. 5 is a perspective view of a cover for the chamber of FIG. 2.

FIG. 6 is an exploded perspective view of an oxygen sensor for use with the chamber of FIG. 2.

FIG. 7 is a cross section view of a mini-electrode for selected ions for use with the chamber of FIG. 2.

FIG. 8 is a customized pH electrode for use with the chamber of FIG. 2

FIG. 9 is a customized light emitting diode and photodiode based sensor for use with the chamber of FIG. 2.

FIG. 10 is a cross section diagram of a bifurcated quartz light guard for use with the chamber of FIG. 2.

### DETAILED DESCRIPTION OF THE INVENTION

In the following description, reference is made to the accompanying drawings that form a part hereof, and in which is shown by way of illustration specific embodiments in which the invention may be practiced. These embodiments are described in sufficient detail to enable those skilled in the art to practice the invention, and it is to be understood that other embodiments may be utilized and that structural, logical and electrical changes may be made without departing from the scope of the present invention. The following description is, therefore, not to be taken in a limited sense, and the scope of the present invention is defined by the appended claims.

Individual parameters of aqueous solutions which may include biological samples are preferably measured independently of each other within the same sample volume, although they all are determined and controlled by the same biological material. It is important that readings by sensors and electrodes used to measure these parameters are not significantly tied to each other, thus allowing monitoring the status of the sample in the most effective and independent way.

A multi-channel recording system includes a measuring chamber, which allows hermetical mounting of a multiple sensors and electrodes within the sample volume. This integration of the multiple elements into one system allows continuous monitoring, acquisition, storage and off-line analysis of the several parameters of aqueous suspensions of the biological samples (mitochondria, bacteria, mammalian cells, dispersed tissues, fungi, etc.). Simultaneous acquisition of the number of independent measurements from the same biological sample eliminates the variability of pooled experimental data measured with separate sensors and electrodes and obtained from different biological samples. This also increases the reliability, the speed and the accuracy of analysis, by avoiding necessity to poll together separate measurements, and facilitates access and manipulation of the sample during measurements. Thus, with these aspects of invention, the biological sample could be thoroughly studied without need for multiple repeatedly performed measurements of various vital parameters using separate sensors and biological samples, required for experimental study.

In one embodiment, a custom-made measuring chamber, having an internal cavity for incubation of the biological sample at a controlled temperature. The sample is studied by measuring multiple parameters with electrodes and sensors, hermetically mounted in the internal cavity and extending into the sample volume to prevent leakage of the aqueous solution as the biological sample is inserted into the measuring volume. A removable air-tight cover is used to seal the container and provide access to cavity for handling the sample.

In another embodiment, the measuring chamber is arranged as a closed volume with magnetic stirring bar inserted into the sample volume to provide mechanical agitation required for accurate and synchronous measurements.

An advantage of the multi-channel recording system is that several vital characteristics of the biological sample are acquired simultaneously and continuously from the same single biological entity, rather than repeating individual measurement using individual sensors or electrodes and separate biological samples for each measurement, which can enable more accurate and complete monitoring, reduce unwanted and excessive usage of expensive biological material and chemical reagents.

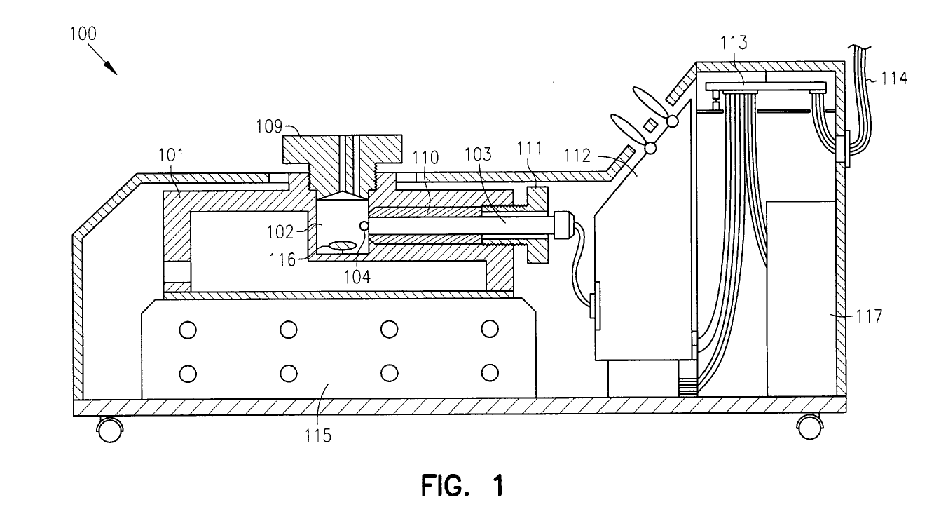

One embodiment of the multi-channel recording system is illustrated in FIG. 1 at 100. System 100 contains a measuring container 101 with a central measuring chamber or sample cavity 102 and a plurality of substantially horizontal through holes or passages, which are used for positioning of multiple sensors and electrodes within the body of measuring container 101. One such sensor shown at 103 extends laterally within the body of measuring container 101 in a way that a sensing part 104 is exposed into the sample cavity 102. In one embodiment, sample cavity 102 is hermetically isolated from oxygen of the air by with an air-tight cover 109. All measuring elements are positioned and secured within the passages using an appropriate holder 110 and mounting tightening knob 111. Signals from sensors are amplified by an analog amplifier 112 and transmitted to analog-to-digital converting board 113, which feed acquired data into the parallel port of the personal computer 114. Processing of such signals is performed in a common manner.

Measuring container 101 is mounted and secured on the top of a magnetic stirrer 115, which spins a magnetic spin-bar 116, located within the sample cavity 102, thus providing mechanical agitation of a biological sample therein. In one embodiment, the magnetic stirrer 115 has no rotating mechanical parts. Generation of rotating force is provided by a rotating magnetic field. In further embodiments, the rotating force may be provided by a magnet attached to a rotor of electrical motor. Measuring container 101 containing measuring elements, analog amplifiers, AD converting board, a power supply 117 and magnetic stirrer are placed within an aluminum box 118 to provide mechanical protection and electrical insulation of sensitive high impedance elements. Other materials may also be used for the box 118. The box also supports a flexible cover that contains a shutter above the opening of the measuring volume, which protects the sample and fluorescent channel against external accidental light. The box may also contain an external source of light for fluorescence excitation.

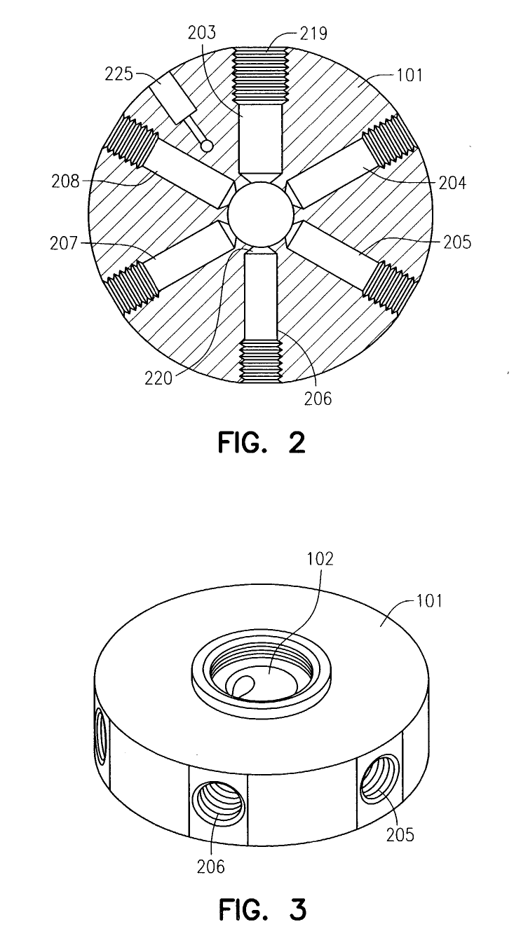

As shown in further cross sectional detail in FIG. 2 and perspective in FIG. 3, the measuring container 101 consists of cylindrical plastic body containing a sample cavity 102 and substantially horizontal passages (in this particular embodiment 6 passages, although this number could be changed) 203, 204, 205, 206, 207 and 208, for mounting of the elements such as sensors using a consistent mounting approach in one embodiment. In further embodiments, the sample cavity is non-cylindrical in shape. It may be spherical, or any other shape, such as having polygonal sides.

Each of the horizontal or lateral passages extends radially from the center of the sample cavity 202, and is radially spaced from each other in one embodiment. The spacing may be varied as desired, and may depend on the shapes of the sensors.

The terms “substantially horizontal” and “substantially lateral” encompass deviations from exactly horizontal. Such deviations include angles above and below a true horizontal wherein such passages are positioned to allow multiple such passages. In one embodiment, adjacent passages are alternately above and below horizontal, such that even more passages may be formed in the measuring container 101. In further embodiments, the passages need not extend exactly radially from the center of the sample cavity 102.

Each passage has a thread 219 proximate the outside edge of the measuring container 101. The threads mate with thread on a mounting knob used for positioning and securing the sensors and electrodes within the body of measuring container 101.

Each passage ends within the wall of the sample cavity 102 by forming the conical ending 220 in one embodiment. A conical ending is used to increase the efficiency of mounting measuring elements within the measuring container 101 and provide hermetical sealing and prevent the leak of fluid from the sample cavity 102. Each element that is mounted into measuring container 101 is sealed within an appropriate holder shown in later figures.

The holder containing the element is supplied with an “inverted” conical ending mating with ending 220, matching that made in appropriate passages within the body of measuring container 101. These conical endings of the passages and holder of elements provide hermetical sealing of elements within the passages of the measuring container and prevent leakage of the fluids from the sample cavity 102 in one embodiment. It also provides electrical insulation of the sample cavity 102 and therefore, sensors and electrodes.

A leak-free seal between the holder 110 and the insertion container passage is achieved by turning a tightening knob (shown in a later figure), which forces the insertion holder into a conical depression within the measuring container 101. This creates a hermetic environment in which leakage does not occur. Each element is mounted within the body of measuring container 101 using similar insertion module containing tightening knob, holder and measuring element, such as sensor or electrode. The measuring container 101 is equipped with two openings 225 comprising an inlet and outlet for circulation of running water having a temperature controlled by a thermostat.

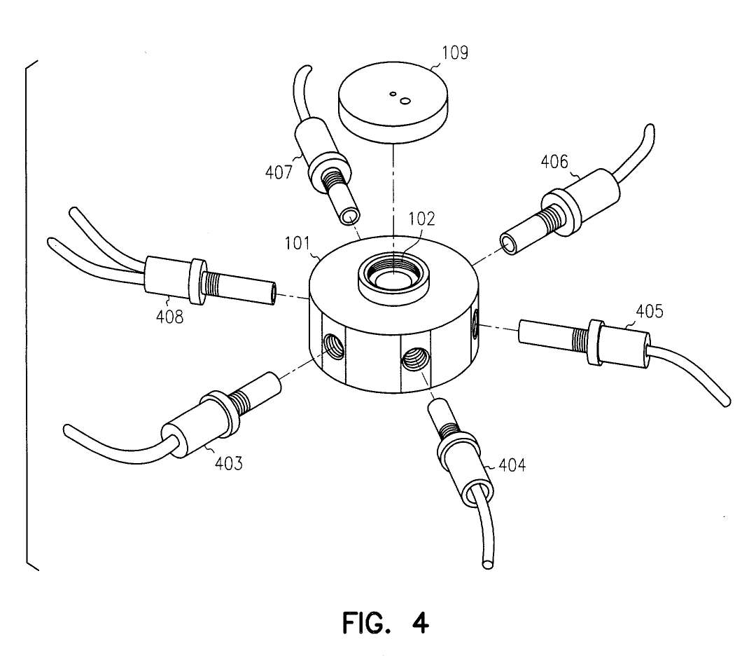

FIG. 4 is a perspective view of the measuring container 101, showing various sensors 403, 404, 405, 406, 407 and 408 that mate with the corresponding passages. Further detail on different sensors and their holders is provided below.

FIG. 5 is a perspective view of cover 109 showing various details. In one embodiment, cover 109 is an air-tight transparent plastic cover comprising of large cylinder 521 with knurled side surface 522 and a small cylinder 523 with thread 524 on the side, to screw it into the body of measuring container 101 and seal sample cavity 102 with a sealing “O” ring 525 placed on an internal surface of the small cylinder 523. Another cylinder 526 of smaller radii and with conical depression 527, matches the diameter of sample cavity 102 within the measuring container 101 so, when assembled, this cylinder enters the sample cavity and “O” ring 525 seals the sample cavity.

Cover 109 contains a central shaft 528, providing an outlet for excessive fluid, and displaced shaft 529 for access to the sample cavity in order to add substances to it. The faces of the cylinders forming cover 109 are polished in one embodiment to allow visual control of the sample. In one embodiment, the cover contains a conical section extending away from the sample cavity 102, with the central shaft 528 centered at the apex of the conical section to enhance removal of gas from the sample cavity.

Many different types of sensors may be modified to fit into the passages of the measuring container 101. The ability to easily modify sensors to operate with the multi-channel recording system greatly increases its flexibility. Several of these modified sensors are described, followed by a general description of the principles of operation of such sensors.

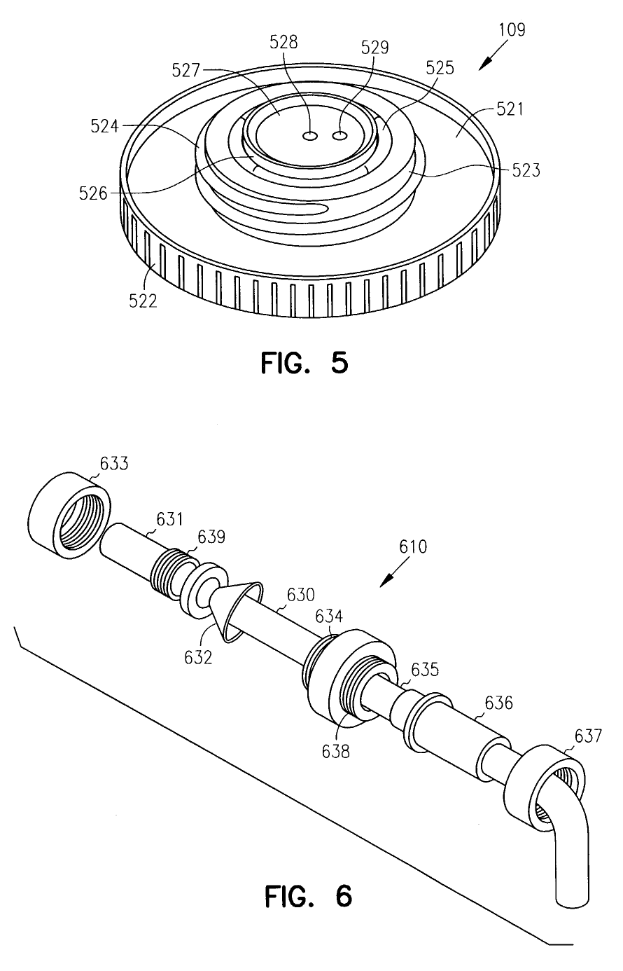

A modified Clark-style oxygen sensor is shown in FIG. 6 at 610. Sensor 610 is constructed so that two halves of the sensor, internal body 630 and external body 631, are assembled to one another, with the gas-permeable membrane 632 between them. The internal body 630 is inserted into external body 631 and secured with tightening knob 633 and thread 634 on the internal body 630 of the oxygen sensor. These two parts of the oxygen sensor squeeze and hold the semi-permeable membrane 632 at the conical depression at the outside end of internal body 630 and internal surface of external body 631, and form a cavity between membrane 632 and the cavity within the internal body 630. The cavity volume formed by gas-permeable membrane and the cavity of internal body 630 is filled with electrolyte. The combination of sensing and reference electrodes of oxygen sensor 635 is mounted on an electrically insulated holder 636 and inserted into the internal body 630 and secured with screw 637 using thread 638 on the internal body 630 of the oxygen sensor. The positioning of the insert should be such that the sensing end of the oxygen sensor approaches the semi-permeable membrane 632 and firmly touches the surface of the membrane so that allowing diffusion of the oxygen into this space. Completed oxygen sensor 610 is positioned into a selected passage of the measuring container 101 and secured within the body of measurement container 101 using thread 639 on the external surface of the external body 631.

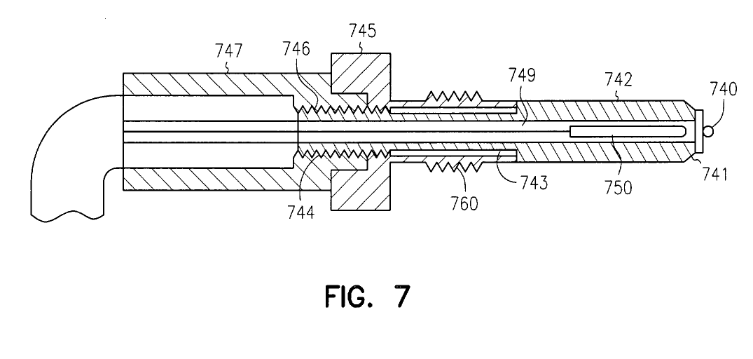

Customized mini-electrodes for Ca²⁺, K⁺ and TPP⁺ are shown in cross section in FIG. 7 at 710. The mini-electrodes comprise an ion-selective membrane 740, glued or otherwise affixed to a conical ending 741 of a large cylinder 742 of the body of the ion-selective electrode. The body tapers off into a cylinder of a smaller radius 743 forming the body of the ion-selective electrode, on which there is engraved thread 744. The small cylinder 743 passes through a tightening knob 745 and is secured by use of the thread 746 within mounting attachment 747. A cavity 749 is formed by the large cylinder 742 of the ion-selective electrode and membrane 740. Cavity 749 is filled with electrolyte and an internal Ag/AgCl connection 750 and mounted and secured within the mounting attachment 747. Completed ion-selective electrode 710 is positioned into a selective passage of the measuring container 101 and secured within the body of measuring container 101 using thread 760 on the external surface of the tightening knob 745, that applies the force to the external end of a large cylinder 742 of the electrode, which translates force into the conical ending 741 on the large cylinder 742, and seals the connection by holding together the conical depression within the horizontal cylindrical passage leading to the sample cavity 102 and conical ending 741 formed on the large cylinder 742 of the body of ion-selective electrode.

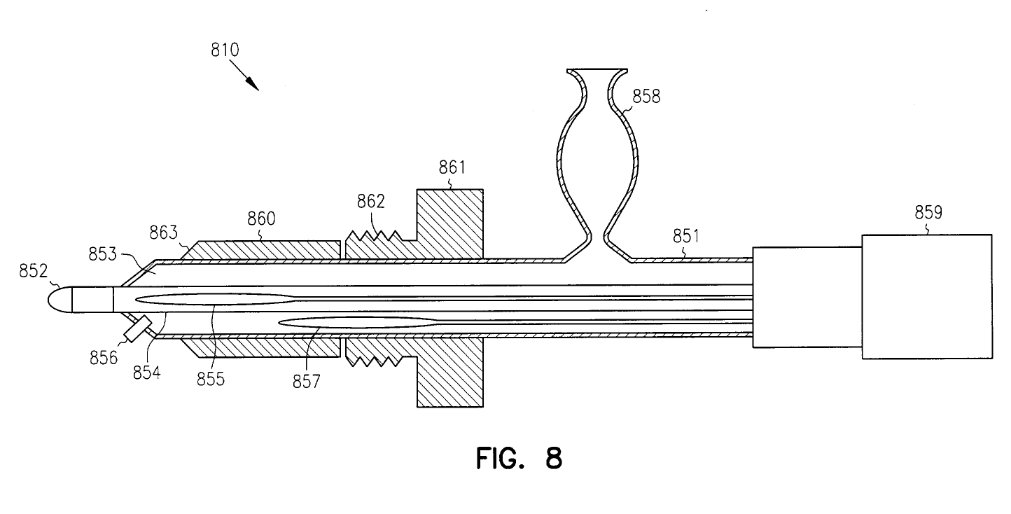

Customized combination pH electrode is shown in cross section in FIG. 8 at 810. The customized pH electrode consisting of cylindrical glass tubing 851 fused with a glass ion-selective membrane 852 to form a cavity 853 that encapsulates another cylindrical tubing 854 containing internal Ag/AgCl connection 855 for monitoring electrical potential across the glass ion-selective membrane 852. The cylinder 851 at the point of fusion with glass ion-sensitive membrane 852 has also orifice 856, plugged with permeable ceramic, allowing electrical contact of incubation medium where pH is measured, with a built-in reference electrode 857.

The tubing 851 is also supplied with a glass “conical bulb” 858 on the side of the glass tubing 851 so it forms the reservoir for filling electrolyte required for normal finctioning of reference electrode 857. Both, internal 855 and reference Ag/AgCl 857 connections are secured in the plastic mounting holder 859 to electrically insulate measuring and reference electrodes and prevent mechanical movement. The customized combination pH electrode 810 is secured and electrically insulated within an electrode holder 860, which comprises a polymerized rubber, such as white silicon or other electrically insulative material.

The assembled electrode is then inserted into the horizontal cylindrical passage leading to the sample cavity 102 and secured within the body of measuring container 101 using thread 862 on the external surface of the tightening knob 861 which applies the force to the holder 860 and to conical ending 863 of the holder and thus seals passage by means of conical mating. Tightening knob 861 is loosely fitted around glass tubing 851 to allow it to rotate freely relative thereto.

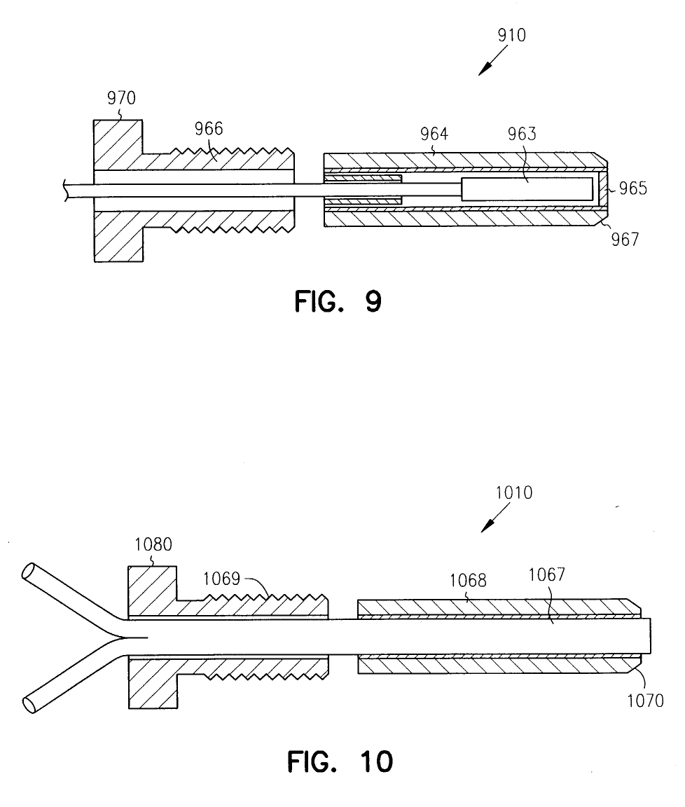

A customized light emitting diode is shown in cross section in FIG. 9 at 910. Light emitting diode 963 is placed and secured inside of a holder 964 with cylindrical cavity inside to comprise the light emitting diode, which contains a transparent quartz glass window 965 inserted and sealed inside the holder 964 in order to provide access of the emitted light to the biological sample placed within the sample cavity 102. Light emitting diode 963 is secured and electrically insulated from sample cavity 102 by sealing of the illumination glass window 965 within the holder 964. Assembled light emitting diode 910 is inserted into a horizontal cylindrical passage leading to the sample cavity 102 and secured within the body of measuring container 101 using thread 966 on the external surface of the tightening knob 970 which applies the force to the holder 964 and to conical ending 967 of the holder and thus seals against conical depression within the passage.

FIG. 9 is also used to represent a receiver for light from the light emitting diode 963. A photodiode, also represented as 963, is similarly placed and secured inside of a holder 964 in place of the light emitting diode. The other elements of FIG. 9 are identical to the elements related to the light emitting diode. The receiver is inserted into a horizontal cylindrical passage leading to the sample. In one embodiment, the receiver is positioned in a passage that is opposed from the light emitting diode. Other positions relative to the light emitting diode may also be utilized.

In one embodiment, the current feeding into the light emitting diode 963 is amplitude (AM)-modulated by a power supply and has a constant frequency, such as 1 KHz. The emitted light is then used to illuminate the sample and the light scattered by the sample then received by the photodiode. The received light is then demodulated, and an increase in amplitude caused by ambient light is removed. The resulting signal is further amplified. Calibration may be performed outside the measuring container 101 by use of a quartz glass, and has resulted in approximately an 8% adjustment. In further embodiments, modulation/demodulation at 1 KHz or other frequency is utilized for a fluorescent light excitation and recording.

A bifurcated quartz light-guard is shown in cross section in FIG. 10 at 1010. A quartz guard 1067 is mounted and secured inside of the appropriate holder 1068 with a cylindrical cavity inside to embrace the quartz guard 1067. The quartz guard 1067 is sealed inside of the holder 1068, thus securing leakage and electrically insulating the guard from sample cavity 102. Assembled bifurcated quartz guard 1010 is inserted into the horizontal cylindrical passage leading to the sample cavity 102 and secured within the body of measuring container 101 using thread 1069 on the external surface of a tightening knob 1080 which applies the force to the holder and to conical ending 1070 of the holder 1068 and thus seals against a conical depression within the passage.

These illustrated sensors are but a few of the sensors that may be adapted to operate with the container. This system allows measurements of the fluorescence at chosen wavelengths, although the fluorescence at different excitation/emission wavelengths also could be adapted within the proposed invention. While mating threads have been shown for attaching the sensors, other attachment methods may also be used. Similarly, while mating conical sections have been described for obtaining seals, other sealing mechanisms such as using rubber “o” rings on the tapered or conical ending may also be utilized.

Once the sensors have been assembled in the container 101 and all passages are occupied, either by a sensor or a sealing plug, the biological sample is placed into the measuring chamber. The sample is continuously stirred and temperature-controlled. The concentrations of oxygen, Ca²⁺, H⁺, K⁺ within this sample are simultaneously measured in one embodiment. The system allows simultaneous measurement of the light scattering at 540-560 nm (either 90° or 180°) and the fluorescence at 470nm. Other wavelengths may also be used. Light scattering measurements are based on the use of an LED coupled with recording photodiode. Fluorescence is excited by a source of excitation light of various wavelengths, such as by laser or an external halogen (iodine) lamp at 340 nm or other wavelength, and the fluorescence is recorded after filtering through 470 nm LP or other filter, with photomultiplier (PMT). Quartz light-guards are used for trafficking the excitation and emission light into and out of the sample.

All signals from electrodes, sensors and optical units are directed to the appropriate analog amplifiers. The data obtained from all measuring elements are transmitted sequentially (10 Hz or other desired rate) to amplifiers and further to an interface, which digitizes these data and send them into PC.

After digitization the signals are directed into software, which operates the apparatus and allows continuous and simultaneous presentation of all or any chosen channels (Ca²⁺, H⁺, K⁺, O₂, light scattering and fluorescence) on the screen using different colors, so the data acquired through sensors and electrodes are readily distinguishable and recognizable. Experimental data could be given a name and stored permanently in the PC's memory. Software allows opening stored files, analyzing and editing the data. The software also allows converting the data into ASCII format, facilitating exchange of the data between graphing editors.

Selected sensor operating principles:

Potentiometry is the field of electroanalytical chemistry in which potential is measured under the conditions of no current flow in electrochemical cells. The potential that develops in this setting (electrochemical cell) is the result of the free energy change that would occur if the chemical phenomena were to proceed until the equilibrium condition has been satisfied. Physical phenomena which do not involve explicit redox reactions, but whose initial conditions have a non-zero free energy, also will generate an electrical potential. An example of this phenomenon is the gradient of the concentration of analyte of interests across a semi-permeable membrane, providing the basis for development of measuring unit called ion-selective electrode.

Ion selective electrodes (ISE) measure the activity of a specific ion (analyte) in solution based on the electrical potential generated across the selective membrane of ISE. When ISE is immersed in a test solution, the electrical potential generated on the membrane could be measured using circuitry containing ISE and reference electrode characterized by constant potential. The potential difference between the two electrodes will depend upon the activity of the specific ion in solution and is the measure of the actual chemical activity of this analyte in solution. This activity is related to the concentration of that specific ion, therefore allowing the end-user to make an analytical measurement of that specific ion. Several ISE's have been developed for a variety of different ions, such as H⁺, Ca²⁺, Na⁺, K⁺, NH₄⁺, CN⁻, S⁻⁻, Ag⁺, Cu²⁺, and Pb²⁺.

Historically, the first ISE were pH-electrodds based on the use of glass membrane, which is selectively permeable only to H⁺ and an internal Ag/AgCl electrode required to create circuitry. The voltage output from the pair of pH (or any other ISEs) and Reference electrodes could be amplified using convenient analog amplifier. An early ISE is the hydrogen-ion selective electrode having a well-behaving glass membrane that has high mobility for H⁺ ion. Subsequently, electrodes are responsive to other cations such as Na⁺, K⁺, and NH₄⁺.

Inorganic salt membrane electrodes are based on inorganic halides and sulphides, for example, silver salts, lanthanum fluoride and heavy-metal sulphides. These membranes have been produced from preparations ranging from whole crystals to dispersions in an inert matrix, such as polythene or silicon rubber. They are targeted at ions such as halides, CN⁻, S⁻⁻, Ag⁺, Cu⁺⁺, and Pb⁺⁺.

Organic membrane electrodes based on neutral carriers generally have the highest selectivity in this class. However, cation exchangers or complexing agents or anion exchangers have been successfully employed in electrodes with liquid or solid membranes, selective to cations or anions, respectively.

Gas sensing electrodes are an extension of ion-selective measurements to detection of gaseous analytes. Gas-sensing probes are complete electrochemical cells, incorporating both the ion-selective electrode and a reference electrode within the sensor. Assay of the target gaseous sample is not performed directly, but is related to a changing parameter (usually pH), which can be monitored by an ion-selective electrode.

Most currently manufactured ion-selective electrodes are now available in both glass and plastic body combination electrodes. Whether the single junction electrode, featuring a spring-loaded sleeve junction with a low maintenance epoxy body, or the double junction glass body electrode is chosen, these ion selective electrodes are easy to use and fit any modern pH/mV meter, ion meter, or on-line instrumentation. The list of ion-selective electrodes currently worldwide available consists from tens of different types, briefly listing the most representative: Ammonia (NH₃)/Ammonium (NH₄⁺); Copper (Cu⁺²); (K⁺); (NO); (NO₃⁻); (Ca⁺²); (Na⁺); (Ca⁺²/Mg⁺²); (I⁻); (CO₂); (Pb⁺²); (Cl⁻); (CN⁻); (Br⁻); (F⁻); (Cd⁺²); (BF₄⁻); (Ag⁺/S⁻²); (X⁺, X⁻).

Polarography is the field of electroanalytical chemistry, where measurement of the current that flows in solution as a function of an applied voltage is used to measure analyte concentration. The actual form of the dependence of the current from applied voltage (observed as a “polarographic wave”) depends upon the manner in which the voltage is applied and on the characteristics of the working electrode.

In an oxygen sensor, when an electrode of noble metal such as platinum or gold is made 0.6 to 0.8 V negative with respect to a suitable reference electrode such as Ag/AgCl or an calomel electrode in a neutral KCl solution, the oxygen dissolved in the liquid is reduced at the surface of the noble metal. This phenomenon can be observed from a current-voltage diagram—called a polarogram —of the electrode. If a fixed voltage (for example, —0.6V) is applied to the cathode, the current output of the electrode is linearly changes with the tension (not concentration) of the dissolved oxygen. A fixed voltage between —0.6 and —0.8 V is usually selected as the polarization voltage when using Ag/AgCl as the reference electrode.

In a Clark-style polarographic electrode, when the cathode, the reference electrode, and the electrolyte are separated from the measurement medium by a polymer membrane, which is permeable to the dissolved gas but not to most of the ions and other species, and when most of the mass transfer resistance is confined in the membrane, the electrode system can measure oxygen tension in various liquids.

Recently optical oxygen sensors based on the use of fiber optics have been developed. They have several advantages over our standard Clark electrodes, including lower maintenance, longer-lasting calibrations, no stirring artifacts, virtually zero oxygen consumption by the sensor, excellent performance at low pO₂ levels, a lower temperature coefficient, and the ability to measure gaseous as well as dissolved oxygen.

The measurements of optical characteristics of biological objects are widely used to monitor variety of processes in biological samples. Monitoring of changes in the cells, mitochondria, and other biological suspensions is achieved through semi-quantitative measurements of the scattered light. This measurement usually exploits trans-illumination of the samples and recording transmitted light, thus measuring absorbance of biological sample reflecting its turbidity, used as a measure of the volume changes by particles forming the sample. Light scattered by biological suspension in the direction of 90° (or 180°) toward the direction of illumination, is proportional to the size of the particles and is used as semi-quantitative measure of the volume of particles forming the sample. Some of the biological samples are characterized by the ability generate fluorescence, light generated by sample upon illumination at chosen wavelength. Recent development of specific fluorescent dyes, which could be loaded into living cells, tissues and organisms, allows investigators to increase the arsenal of available protocols to measure the concentration of such vital ions as intracellular Ca2⁺, K⁺, Na⁺, H⁺, ATP, Mg²⁺ etc. Moreover, discovery of the Green Fluorescent Protein opened a completely new avenue for fluorescent measurements in biology allowing investigators to monitor intracellular protein trafficking, secretion of hormones, etc. . . .

In the developments of the multi-channel monitoring system, optical methods were explored and one channel was included for monitoring of the light scattered by samples, and another channel was included for simultaneously measuring the changes in the natural and/or dye-mediated fluorescence, allowing monitoring of the extracellular and intracellular concentration of such vital ions as Ca²⁺, Na⁺, K⁺, H⁺.

The use of the optical absorbency by biological suspensions has been widely exploited for qualitative volume monitoring using light scattering techniques. The turbidity of the suspension (mitochondria, bacteria, mammalian cells, dispersed tissues, fungi, etc) defines the intensity of scattered light in illuminated suspensions. For this type of qualitative measurements, the suspension is illuminated with the light at neutral wavelength, which does not interfere with biochemical reaction within the organelles (usually 540 nm) and scattered portion of the illuminating light, which reflects the “turbidity volume” of the particles is measured.

Numerous biological processes are monitored from changes in their fluorescence. In order to measure biological fluorescence the object (suspension, single cells, and tissue) is illuminated with the light of high intensity, which is absorbed by object. In response to illumination the object emits, so-called, fluorescent light. The intensity of fluorescence reflects the status of the biological sample. Fluorescence measurements are also used to quantitatively measure the concentrations of some analytes within intracellular compartments, where ISE could not be used. For this purpose cells are loaded with appropriate fluorescent dye and illuminated with chosen excitation wavelength. The intensity of fluorescence of these dyes changes (increases or decreases) with changes in the concentration of the analyte of interest.

1. A device for performing multiple tests on an aqueous solution, the device comprising:
a container having walls defining a sample cavity;
a resealable access in the walls of the container providing access to the sample cavity; and
multiple sensor access ports substantially laterally disposed about the walls of the container that provide access to a sample in the sample cavity by multiple selected sensors.

2. The device of claim 1 and further comprising means for stirring the sample in the sample cavity.

3. The device of claim 1 wherein the resealable access comprises a threaded plug and hole having mated threads.

4. The device of claim 1. wherein the access ports are in a same horizontal plane.

5. The device of claim 1 wherein each access port enables a hermetic seal for a sensor.

6. The device of claim 1 and further comprising multiple ion sensors hermetically sealed in the access ports.

7. The device of claim 1 wherein the walls form a cylinder and are formed of Plexiglas.

8. The device of claim 1 and further comprising a plurality of sensors hermetically sealed in the access ports.

9. The device of claim 8 wherein the sensors include voltage based sensors and at least one powered sensor.

10. The device of claim 9 wherein the powered sensor is insulated from the sample in the chamber.

11. A powered sensor for a multi sensor chamber having multiple sensors for sensing properties of a sample within the chamber, the powered sensor comprising:
a cathode; and
an electrically insulated shaft surrounding the cathode.

12. The powered sensor of claim 11 wherein the shaft is electrically insulated by a gas-permeable membrane.

13. The powered sensor of claim 12 wherein the membrane comprises silicon.

14. The powered sensor of claim 11 wherein the cathode comprises potassium.

15. The powered sensor of claim 14 wherein the powered sensor comprises an oxygen sensor.

16. A device for performing multiple tests on an aqueous solution, the device comprising:
a container having walls for holding a sample;
a resealable access in the walls of the container providing access to the sample; and
multiple sensor access ports substantially laterally disposed about the walls of the container that provide access to the sample by multiple selected sensors;
a plurality of sensors sealed within the ports; and
a reference electrode sealed within a port.

17. The device of claim 16 wherein multiple sensors comprise ion-selective electrodes.

18. The device of claim 17 wherein there is only a single reference electrode.

19. The device of claim 18 wherein the single reference electrode has a high polarization limit.

20. The device of claim 17 wherein one sensor comprises an electrically insulated powered electrode, and at least one of the ion-selective electrodes is voltage based.

21. The device of claim 20 wherein the powered electrode comprises an oxygen sensor.

22. The device of claim 17 wherein the ion-specific electrodes are selected from the group consisting of hydrogen, calcium, potassium, ammonia, and chlorine sensors.

23. The device of claim 17 wherein an access port comprises a cylindrical threaded opening having a conical portion adjacent an inside wall of the container.

24. The device of claim 23 and further comprising a sensor having a tightening knob for engaging mating threads with the access port, and wherein the sensor has a conical portion that mates with the conical portion of the access port.

25. A sensor for a multisensor device having multiple laterally disposed access ports for accessing a sample in a sample cavity, the sensor comprising:
a body portion having a sensor within the body portion and having a conical portion; and
a tightening knob coupled to the body portion, the tightening knob having a threaded portion for mating with threads in the access ports, wherein the conical portion of the body portion is formed to mate with a conical portion of the access ports.

26. The sensor of claim 25 wherein the mating conical portions provide a hermetic seal.

27. A device for performing multiple tests on an aqueous solution, the device comprising:
a container having walls defining a sample cavity;
a resealable access in the walls of the container providing access to the sample cavity;
multiple sensor access ports substantially laterally disposed about the walls of the container that provide access to a sample in the sample cavity by multiple selected sensors; and
a light scattering sensor coupled to one of the access ports comprising a light source emitting an amplitude modulated light and a receiver that receives light scattered by a sample in the sample cavity.

28. The device of claim 27 wherein the amplitude modulated light has a frequency of approximately 1000 Hz.

29. The device of claim 27 wherein the light source is an oscillating LED or xenon lamp.

30. The device of claim 27 wherein received light is demodulated and adjusted to remove effects of ambient light.
